(19) United States
(12) Patent Application Publication
(10) Pub. No.: US 2010/0152867 A1
(43) Pub. Date: Jun. 17, 2010

(54) UNIQUE IDENTIFICATION OF AUTOMATION COMPONENTS

(75) Inventors: Christian Hock, Furth (DE); Karl-Heinz Deiretsbacher, Effeltrich (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, München (DE)

(21) Appl. No.: 12/598,059

(22) PCT Filed: Apr. 4, 2008
(86) PCT No.: PCT/EP08/54115

§ 371 Date: Oct. 29, 2009

(30) Foreign Application Priority Data
Apr. 30, 2007 (DE) 10 2007 020 273.5

(51) Int. Cl. G05B 19/048; G05B 19/02

(52) U.S. Cl. 700/21; 700/86

(57) ABSTRACT

The invention relates to a method for the explicit identification of at least one component of an automation system. The aim of the invention is to propose a method for the explicit identification of automation components that prevents the disadvantages of the known solutions and simplifies project planning. This aim is attained using a method for the worldwide explicit identification of at least one component of an automation system, wherein the component is associated in a one-to-one fashion with location information by means of multidimensional coordinates, said information designating a point inside the component and being transmitted to the automation system and/or being provided for the automation system.

The invention relates to a method for unique identification of at least one component of an automation system.

Such a method is used in the field of automation technology. In automation systems the unique identification of individual components is a fundamental and difficult task. Safety requirements and quantity frameworks often demand logical hierarchies here, which means that the addressing and/or localization of these components from any given points of the system represents a problem. This problem is exacerbated exponentially as the complexity of the system increases.

Sensors and actuators—as the smallest automation components—can store and process more and more information, especially about themselves, and also communicate with one another. These components—independently of the fact that they are communicating with one another—already provide a degree of preprocessing power of their collected information).

This new perspective that sensors/actuators can form networks is assuming ever more importance, especially in automation technology. In such cases it is irrelevant whether the components involved are wired or wirelessly communicating sensors/actuators with an external energy supply or with their own energy supply.

Sensors/actuators can pass on their data both via a point-to-point connection to a concentrator, and also via an intermeshed network infrastructure to a node not specified directly beforehand (an individual sensor/actuator for example). It is pointed out explicitly here that the nodes involved here are not the destination nodes. With a wireless point-to-point connection to a concentrator the concentrator via which an individual sensor/actuator is communicating with the infrastructure can be determined. This assignment is optional however. If no such assignment is made then it occurs at random. Random assignment tends to be the normal case with intermeshed (non-hierarchical) networks. With wired sensors/actuators the assignment to a concentrator will be defined by the wiring.

Previously identifications have typically been assigned in smaller units of an automation system. This means that the uniqueness is only guaranteed within this unit. For system-wide uniqueness the local identifier is frequently supplemented by the identification of the subsystem. With a subdivision into a number of hierarchies the complexity increases. The process just described means that the identification also contains structure information. Thus the identifiers differ according to where the components are being identified from. This does not solve the problem of localization.

Concrete example: In the automation world the wireless sensors/actuators are assigned to a concentrator by—optional—project planning information often to be created manually. On this basis the sensors/actuators will be integrated into the infrastructure so that they can participate in communication. With wired sensors/actuators this assignment to a concentrator—as already mentioned—is made via the wiring. In a similar manner to the wireless case the assignment in intermeshed networks can either be prespecified (e.g. via project planning information), or be produced randomly.

The more numerous the combinations of the different technologies are, the more expensive and error-prone will be both the generation/maintenance/upkeep of project planning for example as well as the later logical assignment of the actual function/functionality to its actual logical group (higher-ranking logical function/functionality). This all also applies when only one technique/technology is used (e.g. with the appropriate quantity of sensors/actuators).

Current methods of establishing a certain logical basic order by definition frequently use the existing communications infrastructure as the first logical ordering parameter. This is however very difficult at the latest with the use of a number of different communication mechanisms (e.g. wired, wireless). All previously-mentioned methods have the disadvantage that as well as the—mostly visual—checking of the arrangement of the automation components, also no one-to-one assignment of said components can be carried out. Likewise mounting location, mounting position and the spatial extent cannot be checked in an automated manner.

The object underlying the invention is to propose a method for unique identification of automation components which avoids the disadvantages of the known solutions.

This object is achieved by a method for worldwide unique identification of at least one component of an automation system, with the component being assigned by means of multi-dimensional coordinates in a one-to-one manner to location information that identifies a point within the component and which is transmitted to the automation system and/or provided for the automation system.

The object is also achieved by a component of an automation system or by an automation system with the features specified in claim 16 or 17 respectively.

A globally unique identification (a GUID) and/or a precise location determination is achieved by the use of multi-dimensional coordinates for the automation components (the sensors/actuators are specified as the smallest here). GUID here does not mean a GUID of the form described in RFC 4122, but in general only the fact of a globally unique ID.

The inventive method is independent of the communication path and/or medium used, provided the information can be transported. All information needed will be supplied by the sensors/actuators themselves (which does not mean that it will also be created by the sensors/actuators).

It is of no significance where a component—for itself—defines the multi-dimensional coordinate point, provided this is located within its physical envelope. Globally-unique information is already generated with this. In this case it is advantageous for use if all components have a well-defined starting point.

The inventive method produces numerous advantages:
Project planning becomes safer and simpler. The position in the coordinate system can be determined for example with commercially-available devices.
Routing of queries can be undertaken on the basis of the coordinates.
A globally-unique identification and thereby an unequivocal access to automation components (e.g. sensors/actuators) can be undertaken - also automated - on the basis of this information.
A logical grouping/assignment is able to be realized independently of available infrastructures.
In OPC servers the coordinate identification can be used directly either as a string for Item ID (classical OPC) or as NodelD (Unified Architecture). With OPC UA it can also already be specified by the namespace that the ID involved is a coordinate GUID.
The coordinate identification allows powerful mapping and navigation tools to be used.

In an advantageous form of the embodiment the location information is determined by the component. Each component for example determines its coordinates when switched on (via GPS for example).

In a further advantageous embodiment the location information will be stored in a non-volatile memory. It is of no significance in this case where and how a component stores the information; in particular it does not absolutely have to be within the physical envelope of the component.

In a further advantageous embodiment the component monitors its location information and reports a deviation from an actual value to the automation system. In this way the component can for example establish a location change on switch-on (and thus determination of the coordinates) and report this where necessary. Naturally by also monitoring during ongoing operation for components which are not identified as having a (planned) ability to change their location but which despite this (e.g. by manipulation) change their location, a message is issued to the automation system and for example an alarm is generated by this system or by the component itself.

In a further advantageous embodiment, if a deviation of its location information is present the component goes from an actual value into a safety state or is put into such a state by the automation system. The component thus, advantageously after the issuing of an alarm signal, switches over into a particular state in which it does not disturb the remaining operation under any circumstances.

In a further advantageous embodiment the location information is supplemented by first time information that specifies when the component was located at the respective location. In the event of components temporarily adding themselves to the system (e.g. service technician with PDA visiting the installation) or for (planned) mobile components, when and where the component was visible for the system is then described by the location/time information. If the component already has a GUID, this will be used. This does not mean that the GUID is permanently changed. The result of the method is that all components each have a unique GUID at any given time.

In a further advantageous embodiment the component provides spatial information about its spatial alignment and/or extent. The component can thus also provide information about its mounting location. The mounting location is information reflecting the spatial alignment of a component. This allows the checking of mounting position and mounting location to be carried out directly down to the physical sensor/actuator.

In a further advantageous embodiment the spatial information will be stored in a non-volatile memory. This memory can naturally be identical to that in which the location information is stored, but however does not absolutely have to be located within the physical envelope of the component.

In a further advantageous embodiment the component monitors its spatial information and reports a deviation from an actual value to the automation system. By this method—in a similar way to monitoring the location information—e.g. even when the component is switched on, a check is made as to whether it is still in the correct mounting location. The actual value in such cases—as of course can the actual value for the location information—be predetermined by a user/operator/project planner. In this exemplary embodiment too the spatial information of the component—again in a similar way to the location information—can likewise be monitored in ongoing operation and where necessary an alarm signal generated.

In a further advantageous embodiment the component switches over from an actual value into a safety state if there is a deviation in its spatial information or is put into such a state by the automation system. Thus in this case too care is also taken that for example on manipulation or with a malfunction which changes the spatial alignment and/or extent in an undesired manner, the component switches over into a particular state in which in does not disturb the remaining operation in any way.

In further advantageous embodiment the spatial information is expanded by second time information that specifies when the component has exhibited the associated alignment and/or extent. Thus changes to the spatial information for moving components and/or for those for which the spatial extent changes can be traced over the course of time. An actual value predetermined where necessary by a user/operator/project planner for monitoring the spatial information for a deviation can in this case—as in a similar manner naturally also the actual value for the location information—be variable over time.

In a further advantageous embodiment a basic value for the location and/or spatial information is stored in a non-volatile memory. A default value for the location and/or spatial information is stored or retrieved respectively by the component by this.

In a further advantageous embodiment a number of components of the automation system are grouped into one component. This means that components can be assembled from components. In particular redundant and/or high-availability components can be recorded as a (combined) component in this way. With redundant and/or high-availability components that are recorded resolved—each for itself—information about the association should advantageously also be provided.

In a further advantageous embodiment all components of the automation system define their location information by means of coordinates of the same coordinate system. The inventive method does not require the use of a specific coordinate system, but the use of just one coordinate system simplifies the use of the components since no recognition or conversion respectively and finally possible standardized storage of the coordinates must be undertaken.

In a further advantageous embodiment the one-to-one location information is used for communication with the component for addressing. This means that the communication layers can use the uniqueness in order for their part to be able to work in an optimized/optimum manner (e.g. by the replacement of MAC addresses by the GUID).

The invention is described in more detail and explained below with reference to the exemplary embodiments shown in the FIGURE. The FIGURE show:

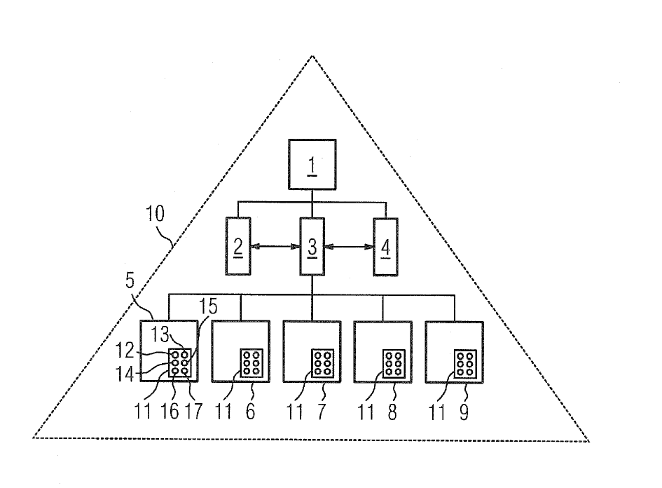

FIG. 1 a schematic diagram of the automation system with different components.

FIG. 1 shows an automation system 10 with different components 1-9 in the form of an “automation pyramid” which represents different hierarchy levels. In this diagram the topmost component 1 can be a PC or a workstation for example, the components 2-4 in the middle level represent a PLC or an industry PC for example, and the components 5-9 symbolize sensors or actuators. The inventive method in this case is independent of the respective communication paths between the different components 1-9; a widely-used realization for the connection between PC 1 and PLC 2-4 is for example Industrial Ethernet (via which the PLCs 2-4 can also communicate with each other), for the connection from the PLCs 2-4 to the sensors and actuators 5-9 an AS interface for example. A non-volatile memory 11 is further shown for the sensors and actuators 5-9, in which different data 12-17 can be stored. (Memory 11 and/or further means for execution of the inventive method can naturally also feature the components 1-4, but are not shown in the FIGURE but are only discussed by way of example with reference to the sensors and actuators 5-9).

It is assumed that at least the component 5 involves a (planned) moveable-location component, so that the location information 12 is supplemented by first time information 13. The location/time information 12, 13 describes when and where the component 5 is or was visible for the system 10. Advantageously the component 5 also has means with which it can also determine the location information 12 itself, for example via GPS. Furthermore the component 5 provides spatial information 14 which is also variable and is thus provided with second time information 15. For the location and spatial information 12, 14 an (advantageously time-dependent) actual value 16 is stored in the memory 11, on the basis of which the component 5 can monitor whether an undesired deviation from this actual value 16 is present, which for example indicates manipulation or a malfunction. Finally a basic value 17 for the location and spatial information 12, 14 is stored which—especially for the spatial information 14—specifies a basic position.

What is shown here using the component 5 by way of example naturally also applies for the other components 1-4, 6-9. In this way the project planning of the automation system 10 becomes far simpler since the components 1-9 provide their own GUID themselves, and especially also far more secure, if they also determine themselves via GPS for example the multi-dimensional coordinates needed for the location information 12. In the automation system 10 the routing of queries can also be undertaken on the basis of the coordinates. In addition the communication layers use the one-to-one location information 12 in order for their part for example to be able to work in an optimized manner by replacing MAC addresses by the GUID for example. The additional spatial information 14 allows checking for mounting position and mounting location to be performed directly down to the physical sensor/actuator. In addition a logical grouping/assignment (e.g. for redundant and/or high-availability components) is able to be realized independently of the present infrastructure.

In summary the invention relates to a method for unique identification of at least one component of an automation system. The underlying object of the invention is to propose a method for unique identification of automation components which avoids the disadvantages of the known solutions and simplifies project planning. This object is achieved by a method for global unique identification of at least one component of an automation system, with the component being assigned in a one-to-one manner, by means of multi-dimensional coordinates, location information which identifies a point within the component and which will be transmitted to the automation system and/or provided for the automation system.

1-17. (canceled)

18. A method for global unique identification of a component of an automation system, comprising the steps of:
assigning to the component in one-to-one correspondence location information represented by multi-dimensional coordinates, said location information identifying a point inside the component, and
transmitting or providing, or both, the location information to the automation system.

19. The method of claim 18, wherein the location information is determined by the component.

20. The method of claim 18, wherein the location information is stored in a non-volatile memory.

21. The method of claim 18, wherein the component monitors the assigned location information and reports a deviation between the assigned location information and an actual value to the automation system.

22. The method of claim 21, wherein if a deviation between the assigned location information and the actual value is detected, the component switches over into a safety state or is placed by the automation system into a safety state.

23. The method of claim 18, further comprising the step of adding a first time information to the location information, said first time information specifying a time when the component was located at a location associated with the location information.

24. The method of claim 18, wherein the component provides spatial information about its spatial alignment or dimension, or both.

25. The method of claim 24, wherein the spatial information is stored in a non-volatile memory.

26. The method of claim 24, wherein the component monitors the spatial information and reports a deviation between the spatial information and an actual value to the automation system.

27. The method of claim 26, wherein if a deviation between the spatial infOrmation and the actual value is detected, the component switches over into a safety state or is placed by the automation system into a safety state.

28. The method of claim 24, further comprising the step of adding a second time information to the spatial information, said second time information specifying a time when the component has assumed the associated alignment or dimension.

29. The method of claim 24, further comprising the step of storing a basic value for a location or the spatial information, or both, in a non-volatile memory.

30. The method of claim 18, wherein the automation system comprises a plurality of components which are grouped into a single component.

31. The method of claim 18, wherein the automation system comprises a plurality of components, and wherein location information of all components is defined in a common coordinate system.

32. The method of claim 18, wherein the one-to-one location information is used for addressing in communication with the component.

33. A component of an automation system comprising:
means for assigning to the component in one-to-one correspondence location information represented by multi-dimensional coordinates, said location information identifying a point inside the component, and
means for transmitting or providing, or both, the location information to the automation system.

34. An automation system having at least one component, comprising:
means for assigning to the at least one component in one-to-one correspondence location information represented by multi-dimensional coordinates, said location information identifying a point inside the at least one component, and
means for transmitting or providing, or both, the location information to the automation system.
